(19) United States
(12) Patent Application Publication
(10) Pub. No.: US 2026/0313023 A1
(43) Pub. Date: Oct. 8, 2026

(54) MEMORY SYSTEM, OPERATING METHOD THEREOF, AND SYSTEM

(71) Applicant: YANGTZE MEMORY TECHNOLOGIES CO., LTD., Wuhan (CN)

(72) Inventors: Jialin PAN, Wuhan (CN); Feng RU, Wuhan (CN); Weilin ZHANG, Wuhan (CN)

(21) Appl. No.: 19/288,858

(22) Filed: Aug. 1, 2025

(30) Foreign Application Priority Data
Apr. 8, 2025 (CN) 2025104356634

(51) Int. Cl. H04L 67/1097; G06F 13/42

(52) U.S. Cl. CPC H04L 67/1097; G06F 13/4221; G06F 2213/0026

(57) ABSTRACT

A memory system comprises a PCIe interface, a first controller, and a second controller; wherein both the first controller and the second controller are coupled to the PCIe interface; wherein the first controller is configured to: in response to a configuration command, configure a first flag bit in the first controller to an enabled state; and in response to the first flag bit being in the enabled state, generate a first data packet, and transmit the first data packet through the PCIe interface; and wherein the second controller is configured to: generate a second data packet, and transmit the second data packet through the PCIe interface, wherein an encapsulation format of the second data packet is different from an encapsulation format of the first data packet.

### CROSS-REFERENCE TO RELATED APPLICATIONS

The present disclosure claims priority to Chinese Patent Application No. 2025104356634, which was filed Apr. 8, 2025, and is hereby incorporated herein by reference in its entirety.

### TECHNICAL FIELD

The present disclosure relates to the field of semiconductor technologies, and in particular, to a memory system, an operating method thereof, and a system.

### BACKGROUND

A device having a Peripheral Component Interconnect Express (PCIe) interface, such as a PCIe solid-state drive (SSD), may be connected to a host through a PCIe interface and a PCIe bus, and interact with the host via the PCIe bus. At present, a PCIe solid-state drive supporting a Non-Volatile Memory Express (NVMe) protocol only supports transmission of data packets in an NVMe over PCIe protocol format, which limits application scenarios of the solid-state drive.

### SUMMARY

In view of this, examples of the present disclosure provide a memory system, an operating method thereof, and a system.

In order to achieve the above objects, the technical solutions of the examples of the present disclosure are implemented as follows:

According to a first aspect, the present disclosure provides a memory system, comprising a PCIe interface, a first controller, and a second controller, wherein both the first controller and the second controller are coupled to the PCIe interface;

the first controller is configured to: in response to a configuration command, configure a first flag bit in the first controller to be in an enabled state; and in response to the first flag bit being in the enabled state, generate a first data packet, and transmit the first data packet through the PCIe interface; and

the second controller is configured to: generate a second data packet, and transmit the second data packet through the PCIe interface, wherein an encapsulation format of the second data packet is different from an encapsulation format of the first data packet.

In an example, the first data packet comprises a first message header and a first payload, the first message header is encapsulated in a PCIe protocol format, and the first payload comprises a first data unit encapsulated in another protocol format different from the PCIe protocol format; and

the second data packet comprises a second message header and a second payload, both of which are encapsulated in the PCIe protocol format.

In an example, the first controller comprises a first class code register configured to store a first class code, the second controller comprises a second class code register configured to store a second class code different from the first class code, and the first class code indicates that the first controller supports transmitting of the first data packet.

In an example, the first controller is further configured to:

before transmitting the first data packet through the PCIe interface, receive a third data packet through the PCIe interface, wherein an encapsulation format of the third data packet is the same as the encapsulation format of the first data packet, the third data packet comprises a second data unit encapsulated in the another protocol format and comprising a connection request, and the first data unit comprises response information for the connection request.

In an example, the first controller comprises a first register group comprising the first flag bit, and the first register group is further configured to store an identifier of a peer device; and the first controller is further configured to:

obtain the identifier of the peer device from the first register group, and encapsulate the identifier of the peer device in the first data packet; and

transmit the first data packet to the peer device through the PCIe interface.

In an example, the first controller further comprises a second register group; and the first controller is further configured to:

store a connection state between the first controller and the peer device in the second register group.

In an example, the memory system further comprises at least one third controller coupled to the PCIe interface, wherein the first controller further comprises a third register group comprising a second flag bit; and the first controller is further configured to:

configure a value of the second flag bit to be in a state indicating that the first controller is a discovery controller; and

store the number of third controllers comprised in the memory system and port information of the third controllers in the third register group.

In an example, the third controller comprises a third class code register configured to store the first class code.

In an example, the third controller is configured to:

transmit a fourth data packet through the PCIe interface, wherein an encapsulation format of the fourth data packet is the same as the encapsulation format of the first data packet, the fourth data packet comprises a third message header and a third payload, and the third payload comprises a third data unit encapsulated in the another protocol format.

In an example, the memory system further comprises a memory device, wherein both the second controller and the third controller are coupled to the memory device;

the third controller is further configured to: obtain first data information from the memory device; encapsulate the first data information in the third data unit; and encapsulate the third data unit in the third payload; and

the second controller is further configured to: obtain second data information from the memory device; and encapsulate the second data information in the second payload.

In an example, the another protocol format comprises a format of a protocol data unit defined by Non-Volatile Memory Express over Transmission Control Protocol.

In an example, the memory system comprises a solid-state drive having the PCIe interface, wherein the solid-state drive comprises the first controller and the second controller.

According to a second aspect, the present disclosure provides a system, comprising a host and a memory system, wherein the memory system comprises a PCIe interface, a first controller, and a second controller, the memory system is coupled to the host through the PCIe interface, and both the first controller and the second controller are coupled to the PCIe interface;

the host is configured to transmit a configuration command, wherein the configuration command indicates to configure a first flag bit in the first controller to be in an enabled state;

the first controller is configured to: in response to the configuration command, configure the first flag bit to be in the enabled state; and in response to the first flag bit being in the enabled state, generate a first data packet, and transmit the first data packet through the PCIe interface; and

the second controller is configured to: generate a second data packet, and transmit the second data packet through the PCIe interface, wherein an encapsulation format of the second data packet is different from an encapsulation format of the first data packet.

In an example, the first data packet comprises a first message header and a first payload, the first message header is encapsulated in a PCIe protocol format, and the first payload comprises a first data unit encapsulated in another protocol format different from the PCIe protocol format;

the second data packet comprises a second message header and a second payload, both of which are encapsulated in the PCIe protocol format.

In an example, the first controller comprises a first class code register configured to store a first class code, the second controller comprises a second class code register configured to store a second class code different from the first class code, and the first class code indicates that the first controller supports transmitting of the first data packet; and the host is further configured to:

query a value stored in the first class code register and a value stored in the second class code register; and

generate the configuration command based on the value stored in the first class code register being the first class code.

In an example, the first controller is further configured to:

before transmitting the first data packet through the PCIe interface, receive a third data packet through the PCIe interface, wherein an encapsulation format of the third data packet is the same as the encapsulation format of the first data packet, the third data packet comprises a second data unit generated in the another protocol format and comprising a connection request, and the first data unit comprises response information for the connection request.

In an example, the system further comprises at least one peer device, wherein the memory system is coupled to the peer device through the PCIe interface, the first controller comprises a first register group comprising the first flag bit, and the first register group is further configured to store an identifier of the peer device; and the first controller is further configured to:

obtain the identifier of the peer device from the first register group, and encapsulate the identifier of the peer device in the first data packet; and

transmit the first data packet to the peer device through the PCIe interface.

In an example, the first controller further comprises a second register group;

the first controller is further configured to: store a connection state between the first controller and the peer device in the second register group; and

the host is further configured to: query the second register group to obtain the connection state between the first controller and the peer device.

In an example, the system comprises a first non-volatile memory subsystem comprising the memory system and a second non-volatile memory subsystem comprising the peer device.

In an example, the memory system further comprises at least one third controller coupled to the PCIe interface, and the first controller further comprises a third register group comprising a second flag bit;

the first controller is further configured to: configure a value of the second flag bit to be in a state indicating that the first controller is a discovery controller; and store the number of third controllers comprised in the memory system and port information of the third controllers in the third register group; and

the host is further configured to: query the third register group to obtain the number of the third controllers and the port information of the third controllers.

In an example, the third controller comprises a third class code register configured to store the first class code.

In an example, the third controller is configured to:

transmit a fourth data packet through the PCIe interface, wherein an encapsulation format of the fourth data packet is the same as the encapsulation format of the first data packet, the fourth data packet comprises a third message header and a third payload, and the third payload comprises a third data unit encapsulated in the another protocol format.

In an example, the memory system further comprises a memory device, and both the second controller and the third controller are coupled to the memory device;

the third controller is further configured to: obtain first data information from the memory device; encapsulate the first data information in the third data unit; and encapsulate the third data unit in the third payload; and

the second controller is further configured to: obtain second data information from the memory device; and encapsulate the second data information in the second payload.

In an example, the another protocol format comprises a format of a protocol data unit defined by Non-Volatile Memory Express over Transmission Control Protocol.

According to a third aspect, the present disclosure provides an operating method of a memory system, comprising:

in response to a configuration command, configuring a first flag bit in a first controller to be in an enabled state;

in response to the first flag bit being in the enabled state, generating a first data packet, and transmitting the first data packet through a PCIe interface; and

generating a second data packet, and transmitting the second data packet through the PCIe interface, wherein an encapsulation format of the second data packet is different from the encapsulation format of the first data packet.

In an example, the operating method further comprises:

before transmitting the first data packet through the PCIe interface, receiving a third data packet through the PCIe interface, wherein an encapsulation format of the third data packet is the same as the encapsulation format of the first data packet, the first data packet comprises a first data unit encapsulated in another protocol format different from a PCIe protocol format, the third data packet comprises a second data unit encapsulated in the another protocol format and comprising a connection request, and the first data unit comprises response information for the connection request.

In an example, the operating method further comprises:

obtaining an identifier of a peer device from a first register group of the first controller, and encapsulating the identifier of the peer device in the first data packet; and

transmitting the first data packet to the peer device through the PCIe interface.

In an example, the operating method further comprises:

storing a connection state between the first controller and the peer device in a second register group of the first controller.

In an example, the operating method further comprises:

configuring a value of a second flag bit in a third register group of the first controller to be in a state indicating that the first controller is a discovery controller; and

storing the number of third controllers and port information of the third controllers in the third register group.

In an example, the operating method further comprises:

transmitting a fourth data packet through the PCIe interface, wherein an encapsulation format of the fourth data packet is the same as the encapsulation format of the first data packet, the fourth data packet comprises a third message header and a third payload, and the third payload comprises a third data unit encapsulated in the another protocol format.

In an example, the operating method further comprises:

obtaining first data information from a memory device, encapsulating the first data information in the third data unit, and encapsulating the third data unit in the third payload; and

obtaining second data information from the memory device, and encapsulating the second data information in a second payload of the second data packet.

### BRIEF DESCRIPTION OF THE DRAWINGS

FIG. 1 is a schematic diagram of an electronic device comprising a memory system according to some examples of the present disclosure;

FIG. 2 is a schematic diagram of a solid-state drive according to some examples of the present disclosure;

FIG. 3 is a first schematic diagram of a memory device according to some examples of the present disclosure;

FIG. 4 is a second schematic diagram of a memory device according to some examples of the present disclosure;

FIG. 5 is a first schematic diagram of a memory system according to some examples of the present disclosure;

FIG. 6 is a second schematic diagram of a memory system according to some examples of the present disclosure;

FIG. 7 is a schematic diagram of registers in a first controller according to some examples of the present disclosure;

FIG. 8 is a schematic diagram of a protocol stack supported by a first controller and a PCIe interface in a memory system according to some examples of the present disclosure;

FIG. 9 is a schematic diagram of a first data packet according to some examples of the present disclosure;

FIG. 10 is a schematic diagram of a fourth data packet according to some examples of the present disclosure;

FIG. 11 is a schematic diagram of a system according to some examples of the present disclosure;

FIG. 12 is a schematic diagram of establishing a connection between a memory system and a host and a peer device in a system according to an example of the present disclosure; and

FIG. 13 is a schematic flowchart of an operating method of a memory system according to some examples of the present disclosure.

### DETAILED DESCRIPTION

Examples of the present disclosure will be described in more detail below with reference to the accompanying drawings. Although examples of the present disclosure are illustrated in the accompanying drawings, it should be understood that the present disclosure may be implemented in various forms and should not be limited to the examples set forth herein. Rather, these examples are provided so that the present disclosure can be more thoroughly understood and the scope disclosed in the present disclosure can be fully conveyed to those skilled in the art.

In the following description, numerous details are given in order to provide a more thorough understanding of the present disclosure. However, it will be apparent to one skilled in the art that the present disclosure may be practiced without one or more of these details. In other examples, in order to avoid confusion with the present disclosure, some technical features known in the art are not described, for example, not all features of the actual examples are described here, and well-known functions and structures are not described in detail.

In the accompanying drawings, like reference numerals refer to like elements throughout.

Terms used herein are for the sole purpose of describing particular examples and should not to be considered as limitations of the present disclosure. As used herein, “a”, “an” and “said/the” in the singular form are intended to comprise the plural forms as well, unless indicated clearly otherwise in the context. It should also be understood that the terms including at least one of “consisting of” or “comprising”, when used in this description, are to identify the presence of at least one of stated features, integers, steps, operations, elements or components, but do not exclude the presence or addition of at least one of one or more other features, integers, steps, operations, elements, components or groups. As used herein, the term “at least one of” comprises any and all combinations of the related listed items.

A memory device in some examples of the present disclosure comprises, but is not limited to, a three-dimensional NAND type memory, and for ease of understanding, the three-dimensional NAND type memory is taken as an example to illustrate.

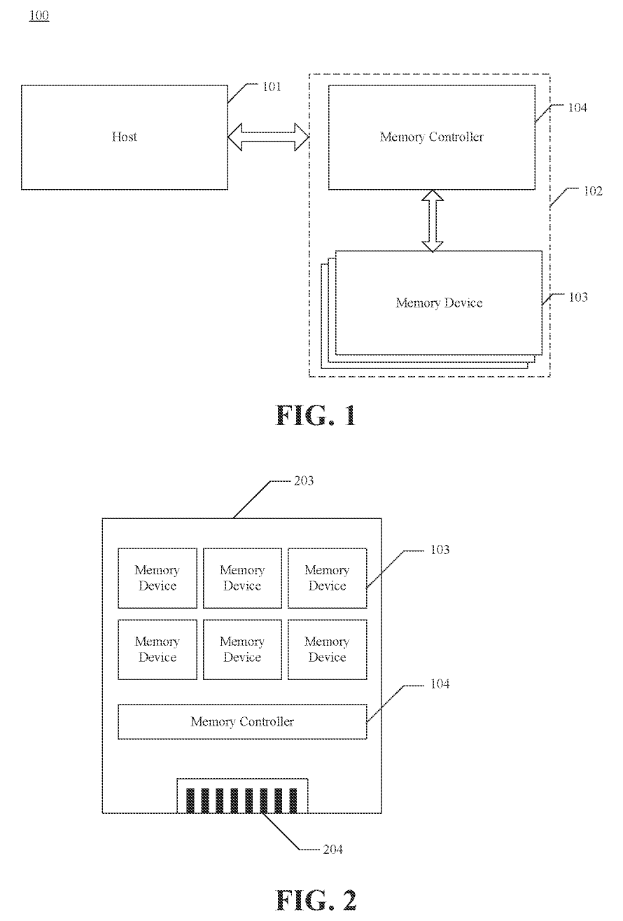

FIG. 1 is a schematic diagram of an electronic device having a memory system according to some examples of the present disclosure. In some examples of the present disclosure, the electronic device 100 may be a mobile phone, a desktop computer, a laptop computer, a tablet computer, a vehicle computer, a game console, a printer, a positioning device, a wearable electronic device, a smart sensor, a virtual reality (VR) device, an augmented reality (AR) device, or any other suitable electronic device having a memory therein. As shown in FIG. 1, the electronic device 100 may comprise a host 101 and a memory system 102, which may comprise one or more memory devices 103 and a memory controller 104. The host 101 may comprise a processor of the electronic device, for example, a central processing unit (CPU), or a system on a chip (SoC), for example, an application processor (AP). The host 101 may be configured to transmit data to the memory system 102 or receive data from the memory system 102.

In some examples, the memory controller 104 is coupled to the memory device 103 and the host 101 and is configured to control the memory device 103. The memory controller 104 may manage data stored in the memory device 103 and communicate with the host 101. In some examples, the memory controller 104 is designed to operate in a high duty cycle environment, such as in a solid-state drive.

In some examples, the memory controller 104 and the one or more memory devices 103 may be integrated into various types of storage devices, for example, the memory system 102 may be implemented and packaged into different types of terminal electronics.

In some examples, referring to FIG. 2, the memory controller 104 and a plurality of memory devices 103 may be integrated into a solid-state drive 203. The solid-state drive 203 may further comprise a solid-state drive connector 204 that couples the solid-state drive 203 to a host (e.g., the host 101 in FIG. 1).

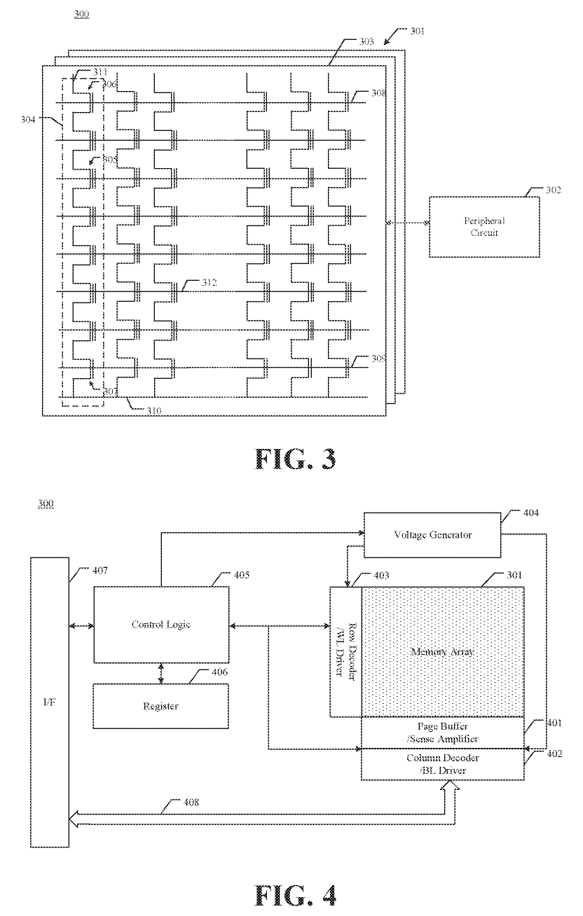

FIG. 3 is a first schematic diagram of a memory device according to some examples of the present disclosure. The memory device 300 may be an example of the memory device 103 in FIG. 1. The memory device 300 may comprise a memory array 301 and a peripheral circuit 302 coupled to the memory array 301. Illustration is made by taking a three-dimensional NAND type memory array as an example of the memory array 301, wherein memory cells 305 are NAND memory cells, the memory cells 305 are provided in the form of an array of memory strings 304, and each memory string 304 extends vertically above a substrate (not shown). In some examples, each memory string 304 comprises a plurality of memory cells 305 coupled in series and stacked vertically. Each memory cell 305 may maintain a continuous analog value, e.g., voltage or charge, which depends on the number of electrons trapped within a region of the memory cell 305. Each memory cell 305 can be either a memory cell of a floating gate type comprising a floating-gate transistor or a memory cell of a charge trap type comprising a charge-trap transistor.

In some examples, each memory cell 305 is a single level cell (SLC) having two possible memory states and thus may store one bit of data. For example, the first memory state “0” may correspond to a first threshold voltage distribution and the second memory state “1” may correspond to a second threshold voltage distribution. In some examples, each memory cell 305 is a multi-level cell capable of storing more than a single bit of data in four or more memory states, e.g., a multi-level cell (MLC) storing two bits per cell, a triple level cell (TLC) storing three bits per cell, or a quad-level cell (QLC) storing four bits per cell.

As shown in FIG. 3, each memory string 304 may comprise a bottom select transistor (BST) 307 at its source terminal and a top select transistor (TST) 306 at its drain terminal. The bottom select transistor 307 and the top select transistor 306 may be configured to activate the selected memory string 304 during read and program operations.

In some examples, the memory array 301 comprises a plurality of memory blocks 303, and the sources of the memory strings 304 in the same memory block 303 may be coupled through a common source line (CSL) 310. In other words, all the memory strings 304 in the same memory block 303 have an array common source (ACS). According to some examples, the top select transistor 306 of each memory string 304 is coupled to a corresponding bit line (BL) 311 from which data can be read or written via an output bus (not shown). In some examples, each memory string 304 is configured to be selected or deselected by at least one of: applying a select voltage (e.g., a voltage higher than a threshold voltage of the top select transistor 306) or a deselect voltage (e.g., 0V) to a top select gate (TSG) of the corresponding top select transistor 306 through one or more top select lines (TSL) 308, or applying a select voltage (e.g., a voltage higher than a threshold voltage of the bottom select transistor 307) or a deselect voltage (e.g., 0V) to a bottom select gate (BSG) of the corresponding bottom select transistor 307 through one or more bottom select lines (BSL) 309.

In some examples, each memory block 303 is a basic data unit for an erase operation, e.g., all memory cells 305 on the same memory block 303 are erased at the same time. To erase memory cells 305 in a selected memory block, a common source line 310 coupled to the selected memory block as well as unselected memory blocks in the same plane as the selected memory block may be biased with an erase voltage. It could be understood that, in some examples, the erase operation may be performed at a half-memory-block level, at a quarter-memory-block level, or at a level of any suitable number of memory blocks or any suitable fraction of a memory block. Memory cells 305 of adjacent memory strings 304 may be coupled by word lines 312 that select which row of memory cells 305 is affected by a read or program operation.

In some examples, the peripheral circuit 302 may comprise any suitable analog, digital, and mixed signal circuit to enable operations on the memory array 301 by applying at least one of voltage signals or current signals to each of target memory cells 305 and sensing at least one of voltage signals or current signals from each of target memory cells 305 through the bit lines 311, the word lines 312, the common source lines 310, the bottom select lines 309, and the top select lines 308. The peripheral circuit 302 may comprise various types of peripheral circuits formed using metal-oxide-semiconductor technology.

FIG. 4 is a second schematic diagram of a memory device according to some examples of the present disclosure. With reference to FIG. 3 and FIG. 4, the peripheral circuit 302 may comprise a page buffer/sense amplifier 401, a column decoder/bit line driver 402, a row decoder/word line driver 403, a voltage generator 404, control logic 405, a register 406, a flash memory interface 407, and a data bus 408. It should be understood that, in some examples, the peripheral circuit may also comprise additional circuits not shown in FIG. 4.

The page buffer/sense amplifier 401 may be configured to read data from the memory array 301 and to program (write) data to the memory array 301 according to control signals from the control logic 405. In one example, the page buffer/sense amplifier 401 may store a page of programmed data (written data) to be programmed into the memory array 301. In another example, the page buffer/sense amplifier 401 may perform a program verification operation to ensure that the data has been properly programmed into the memory cells coupled to the selected word line. In yet another example, the page buffer/sense amplifier 401 may also sense a low power signal from a bit line representing a data bit stored in a memory cell, and amplify a small voltage swing to an identifiable logic level in a read operation. The column decoder/bit line driver 402 may be configured to be controlled by the control logic 405 and to select one or more memory strings by applying a bit line voltage generated from the voltage generator 404.

The row decoder/word line driver 403 may be configured to be controlled by the control logic 405 and to select/deselect a memory block of the memory array 301 and select/deselect a word line of the memory block. The row decoder/word line driver 403 may also be configured to drive a word line using a word line voltage generated from the voltage generator 404. In some examples, the row decoder/word line driver 403 may also select/deselect and drive the bottom select line and the top select line. As described in detail below, the row decoder/word line driver 403 is configured to perform a program operation on memory cells coupled to (one or more) selected word line(s). The voltage generator 404 may be configured to be controlled by the control logic 405 and to generate word line voltages (e.g., reading voltages, programming voltages, passing voltages, local voltages, verifying voltages, etc.), bit line voltages, and source line voltages to be supplied to the memory array 301.

The control logic 405 may be coupled to each peripheral circuit described above and be configured to control operations of each peripheral circuit. The register 406 may be coupled to the control logic 405 and comprise a status register, a command register, and an address register for storing status information, command operation codes (OP codes), and command addresses for controlling operations of each peripheral circuit. The flash memory interface 407 may be coupled to the control logic 405 and act as a control buffer to buffer control commands received from a host (not shown) and relay them to the control logic 405, and to buffer status information received from the control logic 405 and relay it to a memory controller. The flash memory interface 407 may also be coupled to the column decoder/bit line driver 402 via the data bus 408, and act as a data I/O interface and a data buffer to buffer data and transmit it to the memory array 301, or to receive and buffer data from the memory array 301.

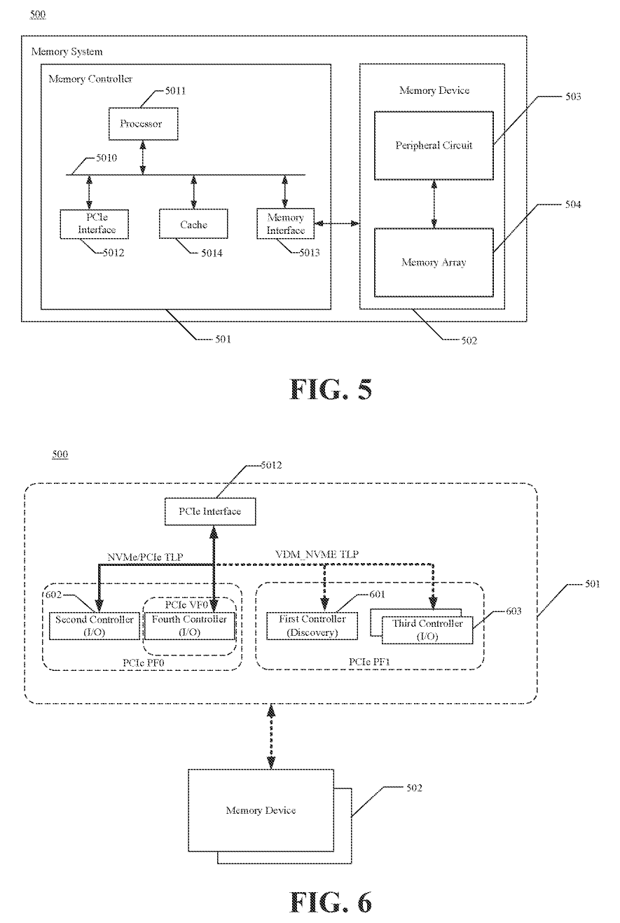

In some examples, FIG. 5 is a schematic diagram of a memory system according to some examples of the present disclosure, where the memory system 500 comprises a memory device 502 and a memory controller 501 coupled to the memory device 502. The memory device 502 comprises a three-dimensional NAND type memory, and in some examples, the memory device 502 comprises a memory array 504 and a peripheral circuit 503 coupled to the memory array 504, and the memory array 504 may be the memory array 301 comprising the NAND memory cells according to the examples discussed above.

In some examples, the memory controller 501 may comprise a processor 5011 and a PCIe interface 5012, a memory interface 5013, and a cache 5014 coupled to the processor 5011 through a bus 5010. The memory controller 501 may be coupled to the memory device 502 through the memory interface 5013, and during the process of data writing, the memory controller 501 may receive the write command, the written data, and the logical address of the written data through the PCIe interface 5012, and may temporarily store the written data in the cache 5014, and it may establish a mapping from logical address to physical address (L2P) for the written data. The memory controller 501 may transmit the program command to the memory device 502 via the memory interface 5013, and the memory device 502 may receive the program command and receive the written data and the physical address of the written data in response to the program command, and store the written data to the location in the memory array 504 corresponding to the physical address of the written data.

In some examples, the processor 5011 may further comprise a front-end controller and a back-end controller, where the front-end controller is coupled to the PCIe interface 5012, and the back-end controller is coupled to the memory interface 5013. Taking the memory system 500 supporting an NVMe over PCIe (NVMe/PCIe) protocol as an example, the front-end controller may implement functions of the NVMe protocol. For example, the front-end controller may encapsulate at least one of an NVMe command or data into a data packet, and transmit the data packet to an external device (for example, a host) through the PCIe interface 5012, and it may also receive a data packet encapsulated with at least one of an NVMe command or data from the external device through the PCIe interface 5012, parse the data packet, and convert the parsed NVMe command into a protocol format supported by the back-end controller (for example, an ONFI protocol, a Toggle protocol, etc.). The back-end controller may receive at least one of the command or the data from the front-end controller, and the back-end controller may be coupled to the memory device 502 through the memory interface 5013, generate a control command in response to the command from the front-end controller, and transmit at least one of the control command or the data to the memory device 502 through the memory interface 5013 to implement flash memory management. Herein, a data packet encapsulated with at least one of an NVMe command or data is a transaction layer packet (TLP) defined in the PCIe protocol format, and in some examples of the present disclosure, such a data packet is denoted as an NVMe/PCIe TLP.

In some examples, a system comprising the memory system may further comprise a peer device, wherein both the memory system and the peer device are coupled to the host, and the memory system and the peer device may belong to different non-volatile memory subsystems (NVM Subsystems). For a system comprising a plurality of non-volatile memory subsystems, data interaction may be performed directly between different non-volatile memory subsystems, but this requires all the non-volatile memory subsystems to support the same protocol; while when data needs to be transmitted between a non-volatile memory subsystem supporting a NVMe-oF (NVMe over Fabrics) protocol and a non-volatile memory subsystem supporting the NVMe/PCIe protocol, the operating system (OS) of the host is still required to act as the memory manager to allocate, schedule, and reclaim the memory resources, and to manage the entire process of protocol conversion and data transmission, which may occupy resources of the operating system, being not conducive to expansion and improvement of system performance.

In this regard, the following examples are provided in the present disclosure.

The present disclosure provides a memory system, and FIG. 6 is a schematic diagram of the memory system according to some examples of the present disclosure. The memory system 500 comprises a PCIe interface 5012, a first controller 601, and a second controller 602, wherein both the first controller 601 and the second controller 602 are coupled to the PCIe interface 5012. The first controller 601 is configured to: in response to a configuration command, configure a first flag bit in the first controller 601 to be in an enabled state; and in response to the first flag bit being in the enabled state, generate a first data packet, and transmit the first data packet through the PCIe interface 5012. The second controller 602 is configured to: generate a second data packet, and transmit the second data packet through the PCIe interface 5012, wherein an encapsulation format of the second data packet is different from an encapsulation format of the first data packet.

In some examples of the present disclosure, both the first controller 601 and the second controller 602 may belong to the memory controller 501 in the memory system 500, and both the first controller 601 and the second controller 602 are coupled to the PCIe interface 5012 in the memory controller 501, wherein when the first flag bit is in the enabled state, the first controller 601 may generate and transmit the first data packet through the PCIe interface 5012, and the second controller 602 may generate and transmit the second data packet through the PCIe interface 5012, wherein the encapsulation format of the first data packet is different from the encapsulation format of the second data packet, thus the memory system 500 may be compatible with two different protocols.

In some examples of the present disclosure, referring to FIG. 6, the first controller 601 and the second controller 602 may be controllers supported by different PCIe physical functions (PF), respectively, and in some examples, the first controller 601 may be a controller supported by PCIe PF1, while the second controller 602 may be a controller supported by PCIe PF0. The first controller 601 and the second controller 602 may have different class codes, support different protocol stacks, and may receive and transmit data packets having different encapsulation formats. In the following, the class codes, protocol stacks and encapsulation formats of data packets for the first controller 601 and the second controller 602 will be described, respectively.

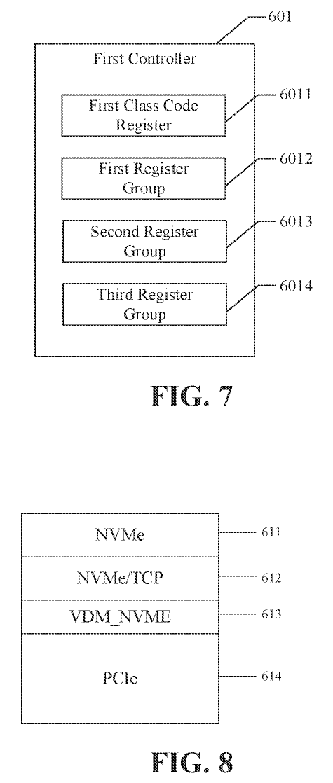

FIG. 7 is a schematic diagram of registers in a first controller according to some examples of the present disclosure. Referring to FIG. 7, the first controller 601 may comprise a first class code register 6011 which may be configured to store a first class code. The first class code may be configured to indicate that the first controller 601 is a controller supported by the PCIe PF1, and the first controller 601 supports transmitting of the first data packet.

In some examples, in the first class code, the class code may be 01h, the subclass code may be 08h, and the programming interface code may be 04h.

FIG. 8 is a schematic diagram of a protocol stack supported by a first controller and a PCIe interface in a memory system according to some examples of the present disclosure. Referring to FIG. 8, the protocol stack may comprise a first layer 611, a second layer 612, a third layer 613, and a fourth layer 614, the functions of which may be implemented by the first controller 601 and the PCIe interface 5012. The first layer 611 may be an application layer defined by the NVMe protocol, and may generate an NVMe command and data. The second layer 612 may be a transport layer defined by a Non-Volatile Memory Express over Transmission Control Protocol (NVMe/TCP) protocol, and may generate a protocol data unit (PDU) that is encapsulated with at least one of the NVMe command or the data, for example, an NVMe/TCP PDU. The third layer 613 may generate a VDM_NVME transaction layer packet (TLP), which may be a data packet that is encapsulated based on a format of a vendor-defined message (VDM) defined by the PCIe protocol and that is encapsulated with the NVMe/TCP PDU. The fourth layer 614 may be a physical layer and a data link layer defined by the PCIe protocol, and may receive or transmit VDM_NVME TLPs. In the examples discussed above, the first data packet generated by the first controller 601 may be a VDM_NVME TLP.

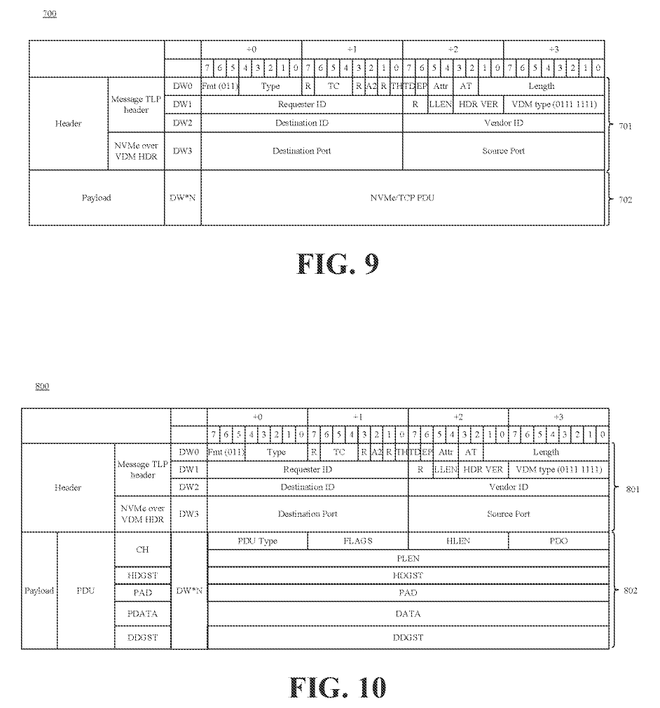

FIG. 9 is a schematic diagram of a first data packet according to some examples of the present disclosure. The first data packet 700 may comprise a first message header 701 and a first payload 702, wherein the first message header 701 is encapsulated in the PCIe protocol format, and comprises a message TLP header with a length of three double words (DW) and a custom header (NVMe over VDM HDR) with a length of one double word. The first payload 702 comprises a first data unit encapsulated in another protocol format. Herein, the another protocol format is a format of a PDU defined by the NVMe/TCP protocol, and the first data unit may be an NVMe/TCP PDU.

In some examples, a value of a Fmt field in the first message header 701 may be configured to be “011”, indicating that the first message header 701 comprises four double words, and the first payload 702 of the first data packet 700 is encapsulated with data (e.g., NVMe/TCP PDU). A value of a Type field in the first message header 701 may be configured to indicate the use of an ID-based routing to transmit the first data packet 700. A value of a VDM type field in the first message header 701 may be configured to be “01111111”, indicating that the first data packet 700 belongs to VDM Type1. A value of a Vendor ID field in the first message header 701 may be configured to indicate that the first data packet 700 is a data packet compatible with the NVMe/PCIe protocol and the NVMe/TCP protocol. A value of a Destination Port field in the first message header 701 which conforms to the definition of the NVMe/TCP protocol may be configured to indicate a port number of a device receiving the first data packet 700. A value of a Source Port field in the first message header 701 which conforms to the definition of the NVMe/TCP protocol may be configured to indicate a port number of the memory system 500. A value of a LLEN field in the first message header 701 may be configured to indicate a length of valid information in the last double word of the first payload 702.

It should be noted that the first message header 701 may further comprise fields that are not mentioned in the examples discussed above, and definitions and functions of these fields all conform to the specification of the PCIe protocol, and details are not described herein again.

In some examples, the second controller 602 comprises a second class code register configured to store a second class code different from the first class code.

In some examples, in the second class code, the class code may be 01h, the subclass code may be 08h, and the programming interface code may be 02h, indicating that the second controller 602 is an input/output controller (I/O controller) supported by the PCIe PF0, and the second controller 602 supports receiving and transmitting of NVMe/PCIe TLPs. Herein, an NVMe/PCIe TLP is a transaction layer packet that is encapsulated in the PCIe protocol format and that is encapsulated with at least one of an NVMe command or data, and the second data packet generated and transmitted by the second controller 602 may be an NVMe/PCIe TLP.

In some examples of the present disclosure, the second controller 602 and the PCIe interface 5012 may implement functions of an NVMe over PCIe protocol stack, and an example hierarchical division of the protocol stack conforms to the specification of the NVMe over PCIe protocol, and details are not described herein again.

In some examples, the second data packet may comprise a second message header and a second payload, wherein both the second message header and the second payload are encapsulated in the PCIe protocol format, and an example format of the PCIe protocol format conforms to the specification of the PCIe protocol, and details are not described herein again.

In some examples, a difference between the encapsulation format of the second data packet and the encapsulation format of the first data packet is mainly reflected in the fact that a first payload portion of the first data packet is a first data unit encapsulated in the NVMe/TCP PDU format, while a second payload portion of the second data packet is at least one of data or command information encapsulated in the PCIe protocol format.

In some examples of the present disclosure, the memory system comprises a first controller and a second controller, wherein the first controller can receive and transmit VDM_NVME TLPs through the PCIe interface, and the second controller can receive and transmit NVMe/PCIe TLPs through the PCIe interface. Thus, the compatibility of the NVMe/PCIe protocol and the NVMe/TCP protocol can be realized, so that the memory system with the PCIe interface can support the NVMe-oF protocol, thus may directly establish the communication connections with other non-volatile memory subsystems supporting the NVMe-oF protocol, thereby reducing the occupation of the operating system resources, and facilitating the expansion and improvement of the system performance.

In some examples of the present disclosure, for a controller (for example, the second controller 602) supported by the PCIe PF0 and a controller (for example, the first controller 601) supported by the PCIe PF1, in addition to the differences in the class code, the supported protocol stack, and the encapsulation format of data packets the transceiving of which is supported, different base address registers (BARs) need to be configured in order to support different physical functions. The BARs in the controller supported by the PCIe PF0 conforms to the specification of the NVMe over PCIe protocol, and details are not described herein again. The example configuration of the BARs in the controller supported by the PCIe PF1 and the example functions which can be implemented by the controller supported by the PCIe PF1 based on the configuration of the BARs will be described below by taking the first controller 601 as an example.

Referring back to FIG. 7, the BARs in the first controller 601 may comprise a first register group 6012, a second register group 6013, and a third register group 6014, wherein the first register group 6012 may be control register(s), the second register group 6013 may be status register(s), and the third register group 6014 may be capability register(s).

In some examples, the first register group 6012 comprises the first flag bit in the examples discussed above, and the first controller 601 may configure the first flag bit to be in the enabled state in response to the configuration command, and receive or transmit VDM_NVME TLPs if the first flag bit is in the enabled state.

In some examples, the length of the first flag bit may be 1 bit, wherein when the first flag bit is set to one of “1” or “0”, the first flag bit is in the enabled state and the first controller 601 may receive or transmit VDM_NVME TLPs, while when the first flag bit is set to another one of “1” or “0”, the first flag bit is in the disabled state and the first controller 601 cannot receive or transmit VDM_NVME TLPs.

In some examples of the present disclosure, the function of the first controller 601 to receive or transmit VDM_NVME TLPs may be in the enabled state or the disabled state, thus the memory system 500 may have flexibility in compatibility of the NVMe-oF protocol.

In some examples, if the first flag bit of the first controller 601 is in the enabled state, the memory system 500 may establish a connection with a host or a peer device through VDM_NVME TLPs. Herein, the peer device may belong to another non-volatile memory subsystem and comprise a PCIe interface, and the memory system 500 and the host may be connected through a PCIe bus, so do the memory system and the peer device.

In some examples, before transmitting the first data packet through the PCIe interface 5012, the first controller 601 is further configured to: receive a third data packet through the PCIe interface 5012, wherein an encapsulation format of the third data packet is the same as the encapsulation format of the first data packet, the third data packet comprises a second data unit encapsulated in the format of the NVMe/TCP PDU and the second data unit comprises a connection request, and the first data unit comprises response information for the connection request.

In some examples, the third data packet may be a VDM_NVME TLP transmitted by the host or the peer device to the memory system 500, and the first controller 601 may receive the third data packet through the PCIe interface 5012. The second data unit in the third data packet may be an NVMe-TCP initialization connection request protocol data unit (NVMe-TCP ICReq PDU) or an NVMe-oF connection request protocol data unit (NVMe-oF connect Req PDU). When the second data unit is an NVMe-TCP ICReq PDU, the first data unit may be an NVMe-TCP initialization connection response protocol data unit (NVMe-TCP ICResp PDU), which comprises the response information for the NVMe-TCP initialization connection request. The first controller 601 may complete the NVMe-TCP initialization connection with the host or the peer device through interaction of the first data packet comprising the first data unit and the second data packet comprising the second data unit. When the second data unit is an NVMe-oF connect Req PDU, the first data unit may be an NVMe-oF connection response protocol data unit (NVMe-oF connect Resp PDU), which comprises the response information for the NVMe-oF connection request. The first controller 601 may establish the NVMe-oF connection with the host or the peer device through interaction of the first data packet comprising the first data unit and the second data packet comprising the second data unit.

In some examples, the first register group 6012 is further configured to store an identifier of the peer device, and the first controller 601 is further configured to: obtain the identifier of the peer device from the first register group 6012, and encapsulate the identifier of the peer device in the first data packet; and transmit the first data packet to the peer device through the PCIe interface 5012.

In some examples, the first register group 6012 may store a BDF list, which comprises a plurality of identifiers of peer devices that may establish a connection with the memory system 500 through VDM_NVME TLPs, and the identifier of the peer device may comprise a bus number, a device number, and a function number of the peer device. Referring to FIG. 9, the first controller 601 may configure a value of a Destination ID field in the first data packet 700 to be the identifier of the peer device, and may configure a value of a Requestor ID field to be the identifier of the memory system 500.

In some examples of the present disclosure, the controller supported by the PCIe PF1 may use an ID-based routing to transmit the first data packet, which may be encapsulated with the identifier of the memory system and the identifier of the peer device receiving the first data packet, thus at least one of the NVMe command or the data may be correctly transmitted between the memory system and the peer device, thereby satisfying the requirement of the NVMe/TCP protocol on the reliability and the ordering of the message interaction.

In some examples, the first controller 601 is further configured to store a connection state between the first controller 601 and the peer device in the second register group 6013. Herein, the connection state between the first controller 601 and the peer device may comprise, but is not limited to, whether the first controller 601 is connected to the peer device, and information about the peer device that is connected to the first controller 601.

In some examples, with reference to FIG. 6 and FIG. 7, the memory system 500 further comprises at least one third controller 603, and the third register group 6014 in the first controller 601 comprises a second flag bit. The first controller 601 is further configured to: configure a value of the second flag bit to be in a state indicating that the first controller 601 is a discovery controller; and store the number of third controllers 603 comprised in the memory system 500 and port information of the third controllers 603 in the third register group 6014.

In some examples, the third controller 603 comprises a third class code register configured to store the first class code. Herein, the class code stored in the third class code register in the third controller 603 is the same as the class code stored in the first class code register in the first controller 601, and the third controller 603 may be an I/O controller supported by the PCIe PF1.

It should be noted that the third controller 603 may comprise the same register configuration as the first controller 601, for example, the third controller 603 also comprises control register(s), status register(s), and capability register(s), but values stored in the registers in the third controller 603 may be different from values stored in the registers in the first controller 601. For example, a capability register of the third controller 603 may also comprise a second flag bit, and the value of the second flag bit in the third controller 603 may be different from the value of the second flag bit in the first controller 601, wherein the value of the second flag bit in the third controller 603 may be configured to be in a state indicating that the third controller 603 is not a discovery controller. Thus, the functions of the first controller 601 and the third controller 603 may be distinguished.

In some examples of the present disclosure, the PCIe PF1 may support a discovery controller (the first controller 601) and an I/O controller (the third controller 603), and then the interaction phase between the controllers supported by the PCIe PF1 and the host may comprise a discovery phase and an I/O operation phase. In some examples, in the discovery phase, the host may obtain information related to the third controller 603 stored in the third register group 6014 of the first controller 601, and the host may be connected to the third controller 603 according to the information related to the third controller 603; and in the I/O operation phase, the host may perform the actual I/O operations through the third controller 603, and the third controller 603 may perform data transmission in response to the command from the host. Similarly, when the memory system 500 establishes a connection with a peer device directly, the peer device may also obtain information related to the third controller 603 from the first controller 601, and establish a connection with the third controller 603, so that the data may be transmitted between the third controller 603 and the peer device.

In some examples, the third controller 603 is configured to: transmit a fourth data packet through the PCIe interface 5012, wherein an encapsulation format of the fourth data packet is the same as the encapsulation format of the first data packet, the fourth data packet comprises a third message header and a third payload, and the third payload comprises a third data unit encapsulated in the format of the NVMe/TCP PDU.

In some examples, FIG. 10 is a schematic diagram of a fourth data packet according to some examples of the present disclosure, wherein the encapsulation format of the fourth data packet 800 is the same as the encapsulation format of the first data packet 700, the fourth data packet 800 comprises a third message header 801 and a third payload 802, and the third payload 802 comprises a third data unit encapsulated in the format of the NVMe/TCP PDU. Herein, the third data unit may comprise header information CH, header information check code HDGST, data information PDATA, and data information check code DDGST.

In some examples, with reference to FIG. 10 and FIG. 6, the memory system 500 further comprises the memory device 502, wherein both the second controller 602 and the third controller 603 are coupled to the memory device 502. The third controller 603 is further configured to: obtain first data information from the memory device 502; encapsulate the first data information in the third data unit, and encapsulate the third data unit in the third payload 802 of the fourth data packet 800. The second controller 602 is further configured to: obtain second data information from the memory device 502; and encapsulate the second data information in the second payload of the second data packet. Herein, the first data information may be encapsulated within the data information PDATA portion of the third data unit.

In some examples of the present disclosure, the I/O controllers supported by different PCIe physical functions in the memory system 500 may share memory resources in the memory system 500. In some examples, both the second controller 602 and the third controller 603 may be coupled to the memory device 502, and obtain data from the memory device 502 or store data into the memory device 502.

In some examples, both the second controller 602 and the third controller 603 are front-end controllers in the memory controller, and then the second controller 602 and the third controller 603 may share one back-end controller and perform data interaction with the memory device 502 through the back-end controller.

In some examples, both the second controller 602 and the third controller 603 have functions of a front-end controller and a back-end controller, and then both the second controller 602 and the third controller 603 may perform data interaction with the memory device 502 directly.

In some examples, referring to FIG. 6, the PCIe PF0 may further support a virtual function (VF). In some examples, the memory system 500 may further comprise a fourth controller, and the fourth controller may be an I/O controller supported by PCIe VF0. The fourth controller may share memory resources in the memory system 500 with the second controller 602 and the third controller 603, and may receive and transmit NVMe/PCIe TLPs through the PCIe interface 5012, so as to establish a communication connection with a virtual machine.

It should be noted that the number of controllers supported by the PCIe PF0 and the number of controllers supported by the PCIe PF1 in FIG. 6 are merely examples, which are not limited in the present disclosure.

In some examples, the memory system 500 comprises a solid-state drive having the PCIe interface 5012, wherein the solid-state drive comprises the first controller 601 and the second controller 602.

In some examples of the present disclosure, the memory system comprises the first controller and the second controller coupled to the PCIe interface, wherein after being configured, the first controller may generate and transmit the first data packet through the PCIe interface, and the first data packet may be a VDM_NVME TLP, which may comprise a first data unit encapsulated in the format of the NVMe/TCP PDU; and the second controller may generate and transmit the second data packet through the PCIe interface, and the second data packet may be an NVMe/PCIe TLP. Thus, compatibility for the NVMe/PCIe protocol and the NVMe/TCP protocol may be realized, so that the memory system having the PCIe interface may support the NVMe-oF protocol, thereby expanding the application scenarios of the memory system.

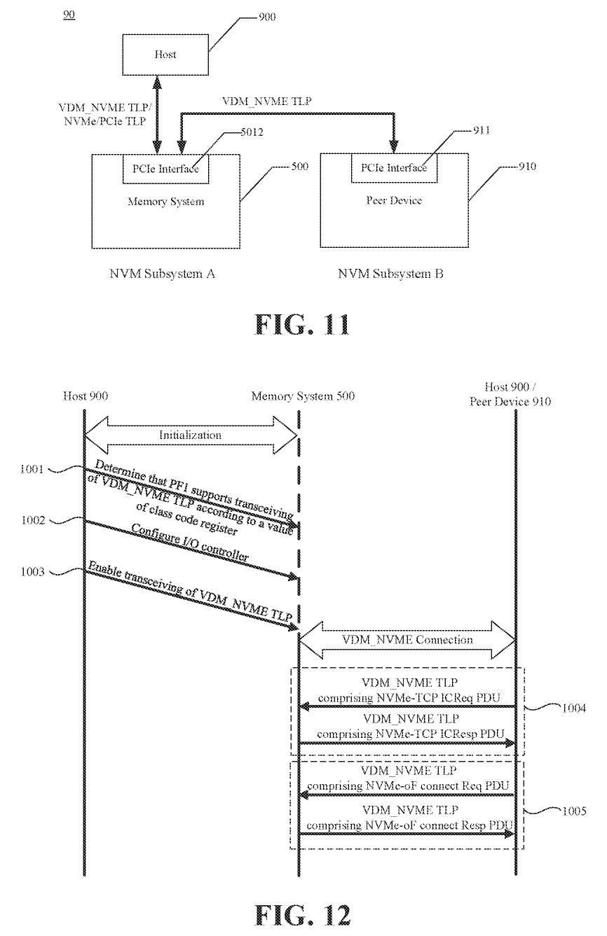

Based on a concept similar to the memory system discussed above, the present disclosure further provides a system, and FIG. 11 is a schematic diagram of the system according to some examples of the present disclosure. With reference to FIG. 6 and FIG. 10, the system 90 comprises a host 900 and a memory system 500, wherein the memory system 500 comprises a PCIe interface 5012, a first controller 601, and a second controller 602. The memory system 500 is coupled to the host 900 through the PCIe interface 5012, and both the first controller 601 and the second controller 602 are coupled to the PCIe interface 5012. The host 900 is configured to: transmit a configuration command, wherein the configuration command indicates to configure a first flag bit in the first controller 601 to be in an enabled state. The first controller 601 is configured to: in response to the configuration command, configure the first flag bit to be in the enabled state; and in response to the first flag bit being in the enabled state, generate a first data packet, and transmit the first data packet through the PCIe interface 5012. The second controller 602 is configured to: generate a second data packet, and transmit the second data packet through the PCIe interface 5012, wherein an encapsulation format of the second data packet is different from an encapsulation format of the first data packet. Herein, the memory system 500 may be the memory system 500 according to any of the examples discussed above.

In some examples, referring to FIG. 9, the first data packet 700 comprises a first message header 701 and a first payload 702, the first message header 701 is encapsulated in a PCIe protocol format, and the first payload 702 comprises a first data unit encapsulated in another protocol format different from the PCIe protocol format. The second data packet comprises a second message header and a second payload, and both the second message header and the second payload are encapsulated in the PCIe protocol format. Herein, the another protocol format is a format of a PDU defined by an NVMe/TCP protocol, and the first data unit may be an NVMe/TCP PDU.

In some examples, the first controller 601 comprises a first class code register, the second controller 602 comprises a second class code register, the first class code register is configured to store a first class code, the second class code register is configured to store a second class code different from the first class code, and the first class code indicates that the first controller supports transmitting of the first data packet. The host is further configured to: query a value stored in the first class code register and a value stored in the second class code register; and generate the configuration command based on the value stored in the first class code register being the first class code.

In some examples, with reference to FIG. 6 and FIG. 7, the memory system 500 further comprises at least one third controller 603, wherein the third controller 603 is coupled to the PCIe interface 5012.

In some examples, the third controller 603 comprises a third class code register, wherein the third class code register is configured to store the first class code.

FIG. 12 is a schematic diagram of establishing a connection between a memory system and a host and a peer device in a system according to an example of the present disclosure. With reference to FIG. 7, FIG. 11, and FIG. 12, in operation 1001 of the initialization phase, the host 900 may obtain values stored in class code registers of a plurality of controllers in the memory system 500, for example, a value stored in a first class code register of the first controller 601, a value stored in a second class code register of the second controller 602, and a value stored in a third class code register of the third controller 603, and according to the values stored in the first class code register and the third class code register being the first class code, determine that the first controller 601 and the third controller 603 are controllers supported by the PCIe PF1, and that the first controller 601 and the third controller 603 support receiving and transmitting of VDM_NVME TLPs. In operation 1002 of the initialization phase, the host 900 may configure I/O controller(s). In some examples, the host 900 may configure an I/O controller supported by the PCIe PF0 (e.g., the second controller 602) and an I/O controller supported by the PCIe PF1 (e.g., the third controller 603). In operation 1003 of the initialization phase, the host 900 may enable transceiving of VDM_NVME TLPs. In some examples, the host 900 may generate and transmit a configuration command indicating to configure a first flag bit in the first controller 601 to be in an enabled state, and the first controller 601 may configure a value of the first flag bit to be in the enabled state in response to the configuration command.

In some examples, the first controller 601 is further configured to: before transmitting the first data packet through the PCIe interface 5012, receive a third data packet through the PCIe interface 5012, wherein an encapsulation format of the third data packet is the same as the encapsulation format of the first data packet, the third data packet comprises a second data unit encapsulated in the format of the NVMe/TCP PDU and the second data unit comprises a connection request, and the first data unit comprises response information for the connection request.

In some examples, referring to FIG. 11, the system 90 further comprises at least one peer device 910, and the memory system 500 is coupled to the peer device 910 through the PCIe interface 5012. Herein, the peer device 910 may comprise a PCIe interface 911, and the PCIe interface 911 of the peer device 910 may be coupled to the PCIe interface 5012 of the memory system 500 through a PCIe bus.

In some examples, with reference to FIG. 11 and FIG. 12, in a VDM_NVME connection phase, the memory system 500 may establish a VDM_NVME connection with the host 900 or the peer device 910. In some examples, the third data packet may be a VDM_NVME TLP comprising an NVMe-TCP ICReq PDU transmitted by the host 900 or the peer device 910 to the memory system 500 in operation 1004, and then the first data packet may be a VDM_NVME TLP comprising an NVMe-TCP ICResp PDU, and the first controller 601 may complete the NVMe-TCP initialization connection with the host 900 or the peer device 910 through interaction of the first data packet and the second data packet. Alternatively, the third data packet may be a VDM_NVME TLP comprising an NVMe-oF connect Req PDU transmitted by the host 900 or the peer device 910 to the memory system 500 in operation 1005, and then the first data packet may be a VDM_NVME TLP comprising an NVMe-oF connect Resp PDU, and the first controller 601 may establish the NVMe-oF connection with the host 900 or the peer device 910 through interaction of the first data packet and the second data packet.

In some examples, the system 90 may comprise a first non-volatile memory subsystem (NVM Subsystem A) and a second non-volatile memory subsystem (NVM Subsystem B), wherein the first non-volatile memory subsystem comprises the memory system 500, and the second non-volatile memory subsystem comprises the peer device 910.

In some examples of the present disclosure, the communication connection can be established between different non-volatile memory subsystems in the system through VDM_NVME TLPs, and then the data can be directly transmitted between the non-volatile memory subsystems, thereby reducing the occupation of resources of the operating system of the host, and facilitating the expansion and improvement of the system performance.

In some examples, with reference to FIG. 7 and FIG. 11, the first controller 601 comprises a first register group 6012, the first register group 6012 comprises a first flag bit, and the first register group 6012 is further configured to store an identifier of the peer device 910. The first controller 601 is further configured to: obtain the identifier of the peer device 910 from the first register group 6012, and encapsulate the identifier of the peer device 910 in the first data packet.

In some examples, with reference to FIG. 7 and FIG. 11, the first controller 601 comprises a second register group 6013. The first controller 601 is further configured to: store a connection state between the first controller 601 and the peer device 910 in the second register group 6013. The host 900 is further configured to: query the second register group 6013 to obtain the connection state between the first controller 601 and the peer device 910.

In some examples, with reference to FIG. 6 and FIG. 7, the first controller 601 further comprises a third register group 6014, and the third register group 6014 comprises a second flag bit. The first controller 601 is further configured to: configure a value of the second flag bit to be in a state indicating that the first controller 601 is a discovery controller; and store the number of third controllers 603 comprised in the memory system 500 and port information of the third controllers 603 in the third register group 6014. The host 900 is further configured to: query the third register group 6014 to obtain the number of the third controllers 603 and the port information of the third controllers 603.

In some examples of the present disclosure, the controller supported by the PCIe PF1 may provide a management window for the host 900. In some examples, taking the first controller 601 as an example, the first controller 601 comprises the first register group 6012, the second register group 6013, and the third register group 6014. The first register group 6012 comprises a first flag bit, and the host may control the enabled state of functions of receiving or transmitting VDM_NVME TLPs by configuring a value of the first flag bit. In addition, the first controller 601 may be used as a discovery controller of the host 900, the host 900 may obtain a connection state between the first controller 601 and the peer device by querying the second register group 6013, may further obtain information related to the third controller 603 by querying the third register group 6014, and may establish a connection with the third controller 603 according to the information related to the third controller 603.

In some examples, the third controller 603 is configured to: transmit a fourth data packet through the PCIe interface 5012, wherein an encapsulation format of the fourth data packet is the same as the encapsulation format of the first data packet. Referring to FIG. 10, the fourth data packet 800 comprises a third message header 801 and a third payload 802, and the third payload 802 comprises a third data unit encapsulated in the format of the NVMe/TCP PDU.

In some examples, with reference to FIG. 6 and FIG. 10, the memory system 500 further comprises the memory device 502, and both the second controller 602 and the third controller 603 are coupled to the memory device 502. The third controller 603 is further configured to: obtain first data information from the memory device 502; encapsulate the first data information in the third data unit; and encapsulate the third data unit in the third payload 802. The second controller 602 is further configured to: obtain second data information from the memory device 502; and encapsulate the second data information in the second payload.

In some examples of the present disclosure, the memory system in the system comprises the first controller and the second controller coupled to the PCIe interface, wherein after being configured by the host, the first controller may generate and transmit the first data packet through the PCIe interface, wherein the first data packet may be a VDM_NVME TLP, which may comprise a first data unit encapsulated in the format of the NVMe/TCP PDU. The second controller may generate and transmit the second data packet through the PCIe interface, wherein the second data packet may be an NVMe/PCIe TLP. Thus, the memory system having the PCIe interface may be made to be compatible with the NVMe-oF protocol, and may directly establish a connection with other non-volatile memory subsystems in the system that support the NVMe-oF protocol, thereby reducing the occupation of operating system resources, and facilitating the expansion and improvement of the system performance.

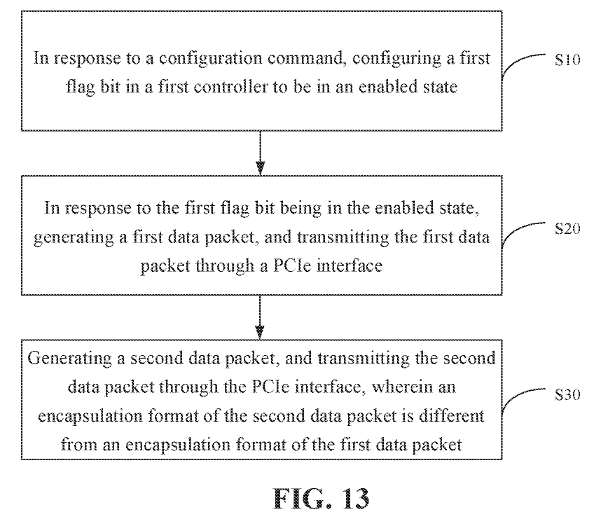

Based on a concept similar to the memory system discussed above, the present disclosure further provides an operating method of a memory system. FIG. 13 is a schematic flowchart of the operating method of the memory system according to some examples of the present disclosure, and the operating method of the memory system comprises the following operations:

Operation S10: in response to a configuration command, configuring a first flag bit in a first controller to be in an enabled state;

Operation S20: in response to the first flag bit being in the enabled state, generating a first data packet, and transmitting the first data packet through a PCIe interface; and

Operation S30: generating a second data packet, and transmitting the second data packet through the PCIe interface, wherein an encapsulation format of the second data packet is different from an encapsulation format of the first data packet.

In some examples, the operating method of the memory system further comprises: before transmitting the first data packet through the PCIe interface, receiving a third data packet through the PCIe interface, wherein an encapsulation format of the third data packet is the same as the encapsulation format of the first data packet, the first data packet comprises a first data unit encapsulated in another protocol format different from a PCIe protocol format, the third data packet comprises a second data unit encapsulated in the another protocol format, the second data unit comprises a connection request, and the first data unit comprises response information for the connection request.

In some examples, the operating method of the memory system further comprises: obtaining an identifier of a peer device from a first register group of the first controller, and encapsulating the identifier of the peer device in the first data packet; and transmitting the first data packet to the peer device through the PCIe interface.

In some examples, the operating method of the memory system further comprises: storing a connection state between the first controller and the peer device in a second register group of the first controller.

In some examples, the operating method of the memory system further comprises: configuring a value of a second flag bit in a third register group of the first controller to be in a state indicating that the first controller is a discovery controller; and storing the number of third controllers and port information of the third controllers in the third register group.

In some examples, the operating method of the memory system further comprises: transmitting a fourth data packet through the PCIe interface, wherein an encapsulation format of the fourth data packet is the same as the encapsulation format of the first data packet, the fourth data packet comprises a third message header and a third payload, and the third payload comprises a third data unit encapsulated in the another protocol format.

In some examples, the operating method of the memory system further comprises: obtaining first data information from a memory device, encapsulating the first data information in the third data unit, and encapsulating the third data unit in the third payload; and obtaining second data information from the memory device, and encapsulating the second data information in a second payload of the second data packet.

The features disclosed in several device examples according to the present disclosure may be arbitrarily combined without conflict, to obtain new device examples.

The methods disclosed in several method examples according to the present disclosure may be arbitrarily combined without conflict, to obtain new method examples.

The above descriptions are only examples of the present disclosure, and the protection scope of the present disclosure is not limited thereto, and changes or replacements that may be easily conceived by any person skilled in the art within the technical scope of the present disclosure should be covered within the protection scope of the present disclosure.

What is claimed is:

1. A memory system, comprising:
a Peripheral Component Interconnect Express (PCIe) interface;
a first controller configured to:
in response to a configuration command, configure a first flag bit in the first controller to be in an enabled state; and
in response to the first flag bit being in the enabled state, generate a first data packet, and transmit the first data packet through the PCIe interface; and
a second controller configured to:
generate a second data packet, and transmit the second data packet through the PCIe interface, wherein an encapsulation format of the second data packet is different from an encapsulation format of the first data packet,
wherein both the first controller and the second controller are coupled to the PCIe interface.

2. The memory system of claim 1, wherein the first data packet comprises a first message header and a first payload, the first message header is encapsulated in a PCIe protocol format, and the first payload comprises a first data unit encapsulated in another protocol format different from the PCIe protocol format; and
wherein the second data packet comprises a second message header and a second payload, both of which are encapsulated in the PCIe protocol format.

3. The memory system of claim 2, wherein the first controller comprises a first class code register configured to store a first class code which indicates that the first controller supports transmitting of the first data packet, and the second controller comprises a second class code register configured to store a second class code different from the first class code.

4. The memory system of claim 2, wherein the first controller is further configured to:
before transmitting the first data packet through the PCIe interface, receive a third data packet through the PCIe interface, wherein an encapsulation format of the third data packet is the same as the encapsulation format of the first data packet, the third data packet comprises a second data unit encapsulated in the another protocol format and comprising a connection request, and the first data unit comprises response information for the connection request.

5. The memory system of claim 1, wherein the first controller comprises a first register group comprising the first flag bit and further configured to store an identifier of a peer device, and the first controller is further configured to:
obtain the identifier of the peer device from the first register group, and encapsulate the identifier of the peer device in the first data packet; and
transmit the first data packet to the peer device through the PCIe interface.

6. The memory system of claim 5, wherein the first controller further comprises a second register group, and the first controller is further configured to:
store a connection state between the first controller and the peer device in the second register group.

7. The memory system of claim 3, further comprising at least one third controller coupled to the PCIe interface, wherein the first controller further comprises a third register group comprising a second flag bit, and the first controller is further configured to:
configure a value of the second flag bit to be in a state indicating that the first controller is a discovery controller; and
store a number of third controllers comprised in the memory system and port information of the third controllers in the third register group.

8. The memory system of claim 7, wherein the third controller comprises a third class code register configured to store the first class code.

9. The memory system of claim 7, wherein the third controller is configured to:
transmit a fourth data packet through the PCIe interface, wherein an encapsulation format of the fourth data packet is the same as the encapsulation format of the first data packet, the fourth data packet comprises a third message header and a third payload, and the third payload comprises a third data unit encapsulated in the another protocol format.

10. The memory system of claim 9, further comprising a memory device which both the second controller and the third controller are coupled to,
wherein the third controller is further configured to:
obtain first data information from the memory device;
encapsulate the first data information in the third data unit; and
encapsulate the third data unit in the third payload; and
wherein the second controller is further configured to:
obtain second data information from the memory device; and
encapsulate the second data information in the second payload.

11. The memory system of claim 2, wherein the another protocol format comprises a format of a protocol data unit defined by Non-Volatile Memory Express over Transmission Control Protocol.

12. The memory system of claim 1, comprising a solid-state drive having the PCIe interface, wherein the solid-state drive comprises the first controller and the second controller.

13. A system, comprising:
a host configured to:
transmit a configuration command which indicates to configure a first flag bit in a first controller to be in an enabled state; and
a memory system comprising:
a Peripheral Component Interconnect Express (PCIe) interface;
the first controller configured to:
in response to the configuration command, configure the first flag bit to be in the enabled state; and
in response to the first flag bit being in the enabled state, generate a first data packet, and transmit the first data packet through the PCIe interface; and
a second controller configured to:
generate a second data packet, and transmit the second data packet through the PCIe interface, wherein an encapsulation format of the second data packet is different from an encapsulation format of the first data packet,
wherein the memory system is coupled to the host through the PCIe interface, and both the first controller and the second controller are coupled to the PCIe interface.

14. An operating method of a memory system, comprising:
in response to a configuration command, configuring a first flag bit in a first controller to be in an enabled state;
in response to the first flag bit being in the enabled state, generating a first data packet, and transmitting the first data packet through a Peripheral Component Interconnect Express (PCIe) interface; and
generating a second data packet, and transmitting the second data packet through the PCIe interface, wherein an encapsulation format of the second data packet is different from an encapsulation format of the first data packet.

15. The operating method of the memory system of claim 14, further comprising:
before transmitting the first data packet through the PCIe interface, receiving a third data packet through the PCIe interface, wherein an encapsulation format of the third data packet is the same as the encapsulation format of the first data packet, the first data packet comprises a first data unit encapsulated in another protocol format different from a PCIe protocol format, the third data packet comprises a second data unit encapsulated in the another protocol format and comprising a connection request, and the first data unit comprises response information for the connection request.

16. The operating method of the memory system of claim 14, further comprising:
obtaining an identifier of a peer device from a first register group of the first controller, and encapsulating the identifier of the peer device in the first data packet; and
transmitting the first data packet to the peer device through the PCIe interface.

17. The operating method of the memory system of claim 16, further comprising:
storing a connection state between the first controller and the peer device in a second register group of the first controller.

18. The operating method of the memory system of claim 15, further comprising:
configuring a value of a second flag bit in a third register group of the first controller to be in a state indicating that the first controller is a discovery controller; and
storing a number of third controllers and port information of the third controllers in the third register group.

19. The operating method of the memory system of claim 18, further comprising:
transmitting a fourth data packet through the PCIe interface, wherein an encapsulation format of the fourth data packet is the same as the encapsulation format of the first data packet, the fourth data packet comprises a third message header and a third payload, and the third payload comprises a third data unit encapsulated in the another protocol format.

20. The operating method of the memory system of claim 19, further comprising:
obtaining first data information from a memory device, encapsulating the first data information in the third data unit, and encapsulating the third data unit in the third payload; and
obtaining second data information from the memory device, and encapsulating the second data information in a second payload of the second data packet.
